(19) United States
(12) Patent Application Publication
(10) Pub. No.: US 2012/0284135 A1
(43) Pub. Date: Nov. 8, 2012

(54) PROXIMITY BASED ONLINE MARKETPLACE

(75) Inventors: Ian HUNTER, West Hollywood, CA (US); Bowman D. FISHBACK, Kansas City, MO (US); Eric A. KOESTER, Seattle, WA (US)

(73) Assignee: Zaarly, Inc., San Francisco, CA (US)

(21) Appl. No.: 13/099,944

(22) Filed: May 3, 2011

(51) Int. Cl. G06Q 30/00

(52) U.S. Cl. 705/26.3; 705/27.1; 705/26.4

(57) ABSTRACT

A online marketplace that can connect nearby buyers and sellers in a time-sensitive and efficient manner. The system can enable users who want something to connect with nearby users who can provide that something by utilizing automatically detected location data from the users' computing devices. The system can allow both buyers and sellers to post listings, and can also allow listings to define multiple quantities of an item or service and allow multiple offers to be made and accepted on such listings via an auction mechanism. The system can improve the efficiency with which buyers and sellers can quickly find each other by not allowing users to submit offers on listings with price changes that degrade the listing. The system can also improve the efficiency with which buyers and sellers complete their transaction by facilitating a peer-to-peer payment process with dispute resolution controls.

### FIELD OF THE DISCLOSURE

This relates to online marketplaces, including bringing together nearby buyers and sellers in a time-sensitive and efficient manner.

### BACKGROUND

Buyers can connect with sellers in different ways over the Internet. For example, online auction sites such as eBay® allow sellers to post auction-style listings that enable buyers to win the item they want by taking part in a bidding process. Online listing services such as craigslist® allows sellers to post simple classified-style listings in the hopes of attracting buyers. Sellers post listings on these sites with the hope that buyers will be able to find their listings and transact with them.

To help buyers find the listings they want, such sites allow buyers to search listings by keywords and/or browse listings by categories, such as type of item for sale or region, under which sellers have posted their listings. However, such searching and browsing, despite the level of granularity of the search queries and categories, tend to provide an overwhelming number of listings that are not of interest to the buyers.

Accordingly, such sites do not provide an effective way for buyers to find what they are looking for when they want it.

### SUMMARY

A online marketplace is disclosed that can connect nearby buyers and sellers in a time-sensitive and efficient manner. The system enables buyers and sellers to be matched in real-time and to conduct time-sensitive and face-to-face transactions.

For example, the system can enable users who want something to connect with nearby users who have that something by utilizing automatically detected location data from the users' computing devices.

For example, when a first user posts a listing on the system for a desired item or service from the first user's computing device, the system can utilize location data, such as latitude and longitude coordinates, from the first user's computing device to define a search radius around the first user's location. The system can subsequently push the first user's listing to any other user registered with the system who is associated with a group in the system that is associated with a location within the search radius.

Similarly, when a second user requests to browse listings on the system from the second user's computing device, the system can utilize location data from the second user's computing device to define a search radius around the second user's location and to provide listings that are associated with a location within the search radius.

Further, when the second user makes an offer on the first user's listing on the system from the second user's computing device, the system can associate location data from the second user's computing device with the offer in the system. Therefore, when the first user requests to browse offers on the first user's listings on the system from the first user's computing device, the system can utilize location data from the first user's computing device to define a search radius around the first user's location and to provide offers on the first user's listings that are associated with a location within the search radius.

The system can allow both buyers and sellers to post listings. For example, a listing can define a request for an offer that includes a description and a price. The offer can comprise an offer to buy, in which case the description can comprise an item or service that a user associated with the listing wants to buy and the price can comprise an amount the user is willing to pay for the item or service. Conversely, the offer can comprise an offer to sell, in which case the description can comprise an item or service that a user associated with the listing wants to sell and the price can comprise an amount for which the user is willing to sell the item or service. The system can also allow listings to define multiple quantities of an item or service and allow multiple offers to be made and accepted on such listings via an auction mechanism.

The system can also improve the efficiency with which buyers and sellers can quickly find each other by not allowing users to submit offers on listings with price changes that degrade the listing. This enforces the notion that users who post listings are willing to pay a premium for an item or service, or sell an item or service at a discount, for quicker action on the listing or better service offered in response to the listing.

For example, the system can allow a buyer to post a listing indicating that the buyer is willing to pay a certain price for a certain service to be performed. The system can also allow a seller to respond to that listing with an offer to perform the indicated service for a price that is different from the buyer's indicated price. However, the system can reject the seller's price change if the seller's offered price is less than the buyer's indicated price, since the seller's offered price degrades the buyer's listing. Conversely, if the seller's offered price is more than the buyer's indicated price, the system can proceed to notify the buyer of the offer with the proposed price change and facilitate further communication between the buyer and seller.

The system can also improve the efficiency with which buyers and sellers complete their transaction by facilitating a peer-to-peer payment process with dispute resolution controls.

For example, when it is time for the buyer to pay the seller, the system can set up a transaction in which the buyer provides the payment to a payment processor, which in turn provides the payment to the seller. However, the system can also enforce a hold on the payment from the payment processor to the seller for a period of time to ensure that any disputes are resolved prior to release of the funds to the seller.

### BRIEF DESCRIPTION OF THE DRAWINGS

FIG. 1 illustrates an example of a network architecture in accordance with one embodiment.

FIG. 2 illustrates an example of a listing process in accordance with one embodiment.

FIG. 3 illustrates an example of a browsing process in accordance with one embodiment.

FIG. 4 illustrates an example of a bidding process in accordance with one embodiment.

FIG. 5 illustrates an example of an offer consideration and acceptance process in accordance with one embodiment.

FIG. 6 illustrates an example of a process for a listing having multiple quantities in accordance with one embodiment.

FIG. 7 illustrates an example of a network architecture in accordance with one embodiment.

FIG. 8 illustrates an example of a payment process in accordance with one embodiment.

FIGS. 9-40 illustrate examples of client user interfaces in accordance with embodiments.

FIG. 41 illustrates an example of computing device in accordance with one embodiment.

### DETAILED DESCRIPTION

Embodiments of the present disclosure provide a system that enables nearby buyers and sellers to be connected in a time-sensitive and efficient manner.

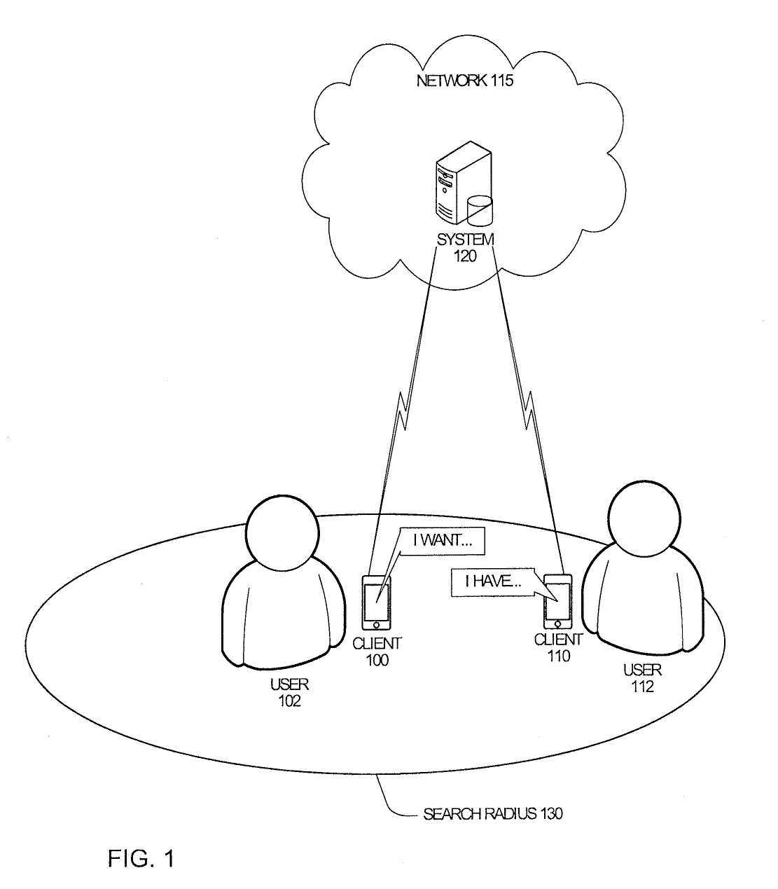

FIG. 1 illustrates an example of a network architecture in accordance with one embodiment. In the embodiment illustrated in FIG. 1, system 120 comprises an online system configured to provide access, management and transaction support in connection with users' listings. Client 100 and client 110 comprise any suitable computing device, such as a stationary computing device (e.g., desktop computer) or mobile computing device (e.g., phone, tablet), that can be configured to access, manage and transact listings hosted by system 120 over network 115. System 120 can include a server and database. The database can store, for example, listings posted and accessed by users of system 120. The server can implement the functionality of system 120 as described herein in connection with the accessing, managing and transacting of users' listings.

System 120 can allow both buyers and sellers to post listings. For example, a listing can define a request for an offer that includes a description and a price. The offer can comprise an offer to buy, in which case the description can comprise an item or service that a user associated with the listing wants to buy and the price can comprise an amount the user is willing to pay for the item or service. Conversely, the offer can comprise an offer to sell, in which case the description can comprise an item or service that a user associated with the listing wants to sell and the price can comprise an amount for which the user is willing to sell the item or service. The system can also allow listings to define multiple quantities of an item or service and allow multiple offers to be made and accepted on such listings via an auction mechanism as described below.

To provide context for some of the embodiments that follow, user 102 can represent an operator of client 100 and user 112 can represent an operator of client 110. User 102 can use client 100 to post a listing on system 120 indicating what user 102 wants. User 112 can use client 110 to respond to the listing, indicating that user 112 has what user 102 wants.

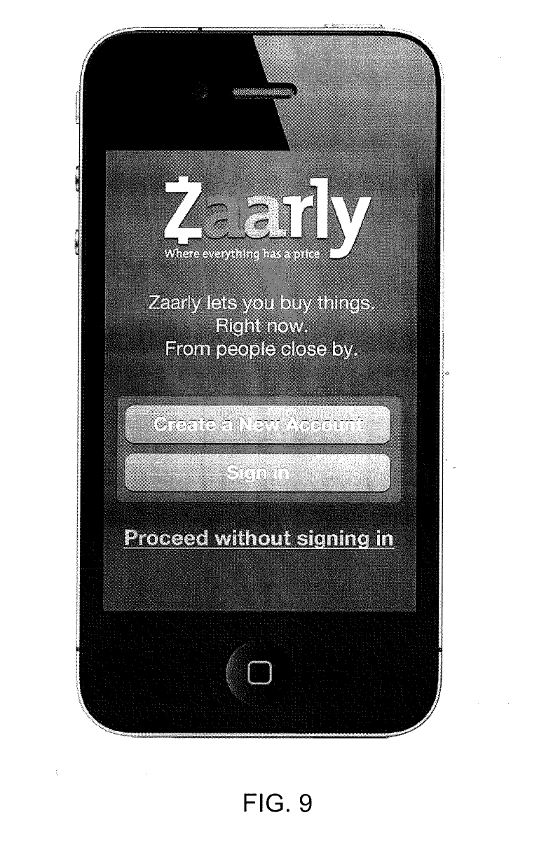

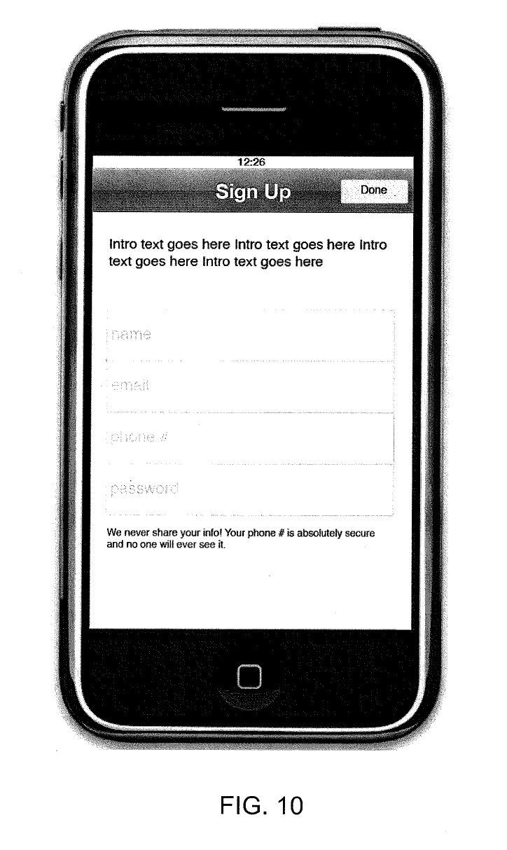

In order to allow user 102 to post a listing, system 120 can provide a registration process through which user 102 can create an account with system 120. FIGS. 9 and 10 depict example registration user interfaces that can be displayed on client 100.

As depicted in FIG. 9, system 120 can provide user 102 with an option to sign in, to create a new account or to proceed without signing in. The option to sign in can be provided to allow users who are registered with system 120 to sign in. The option to create a new account can be provided to sign up users who have not yet registered with system 120 but seek to access particular features of system 120 that can require registration, such as posting a listing or responding to a listing. The option to proceed without signing in option can be provided to allow users who are not registered with system 120 to gain access to particular features of system 120 that do not require registration, such as browsing listings. In another embodiment, system 120 can lack an option to proceed without signing in and require all users to be registered with system 120 in order to access any feature of system 120.

As depicted in FIG. 10, system 120 can request that user 102 provide account information, such as name, contact information such as e-mail address and phone number, and a password. System 120 can utilize the contact information to contact user 102 at suitable times, such as to facilitate communication between user 102 and user 112 in connection with user 102's listing. As described below, system 120 can maintain confidentiality of user 102's contact information by acting as an intermediary in the facilitated communication between user 102 and user 112. System 120 can require the password as part of the sign-in process to prevent unauthorized access to user 102's account.

During the registration process, system 120 can also provide user 102 with an option to join and/or create one or more groups in system 120. A group in system 120 generally refers to a collection of users of system 120 that are associated with one another in system 120, such as in a database. By allowing users to associate themselves in groups, system 120 can provide group-based notifications of certain listings as described herein.

System 120 can provide users who create a group with an option to allow either open access or restricted access to other users becoming associated with the group. Under the open access option, system 120 can allow any user to become associated with the group automatically upon request, such as a request by a user to join the group as a member or to follow the group. Under the restricted access option, system 120 can allow the user who created the group to allow or deny association with the group to a user requesting to be associated with the group.

A group can also be associated in system 120 with location data corresponding to a particular geographic location. Location data generally corresponds to data that provides an absolute location of a place using a recognized coordinate system, such as latitude and longitude coordinates. For example, a group having a tie to a geographic region, such as a group representing a university or neighborhood, can be associated in system 120 with location data corresponding to a particular location within that geographic region. System 120 can also permit groups to lack any association in system 120 with location data corresponding to a particular geographic location.

System 120 can enable a user who creates a group to specify and maintain profile information about the group and to control membership of the group. Profile information to be specified by the group creator can include description of the group to be exposed to other users of system 120. The description can include any information suitable to describe the group, such as title information and description information. Title information generally corresponds to a relatively short and summary description of the group, while description information generally corresponds to a relatively longer and detailed description of the group. If the group creator chooses to associate the group with a location, the profile information to be specified by the group creator can also include a location such as an address. System 120 can use the specified location to lookup location data corresponding to the specified location and to associate the looked up location data with the group in system 120. System 120 can also delete a group if a certain number of users fail to join or follow the group after a certain period of time.

In connection with posting and browsing listings, system 120 can enable user 102 to connect with a nearby user, such as user 112, within a particular proximity of client 100, such as search radius 130, by utilizing automatically detected location data from client 100 and client 110.

In particular, when user 102 posts a listing on system 120 for a desired item or service from client 100, system 120 can utilize location data, such as latitude and longitude coordinates, from client 100 to define search radius 130 around user 102's location. System 120 can subsequently push user 102's listing to any other user registered with system 120, such as user 112, who is associated with a group in system 120 that is associated with a location within search radius 130.

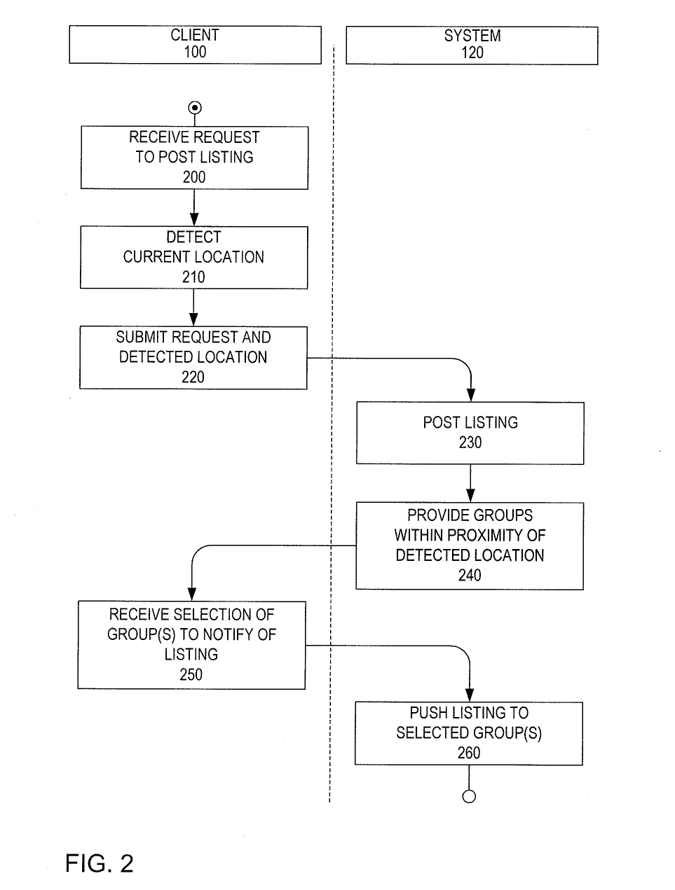

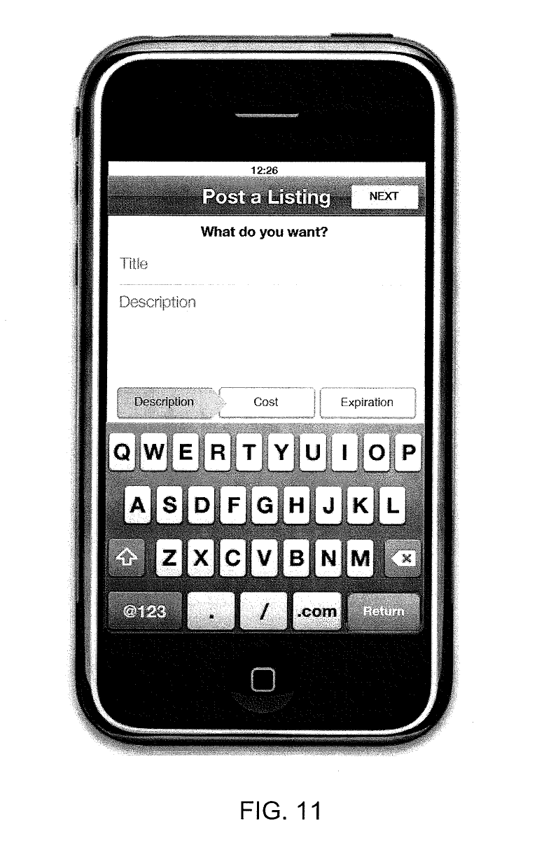

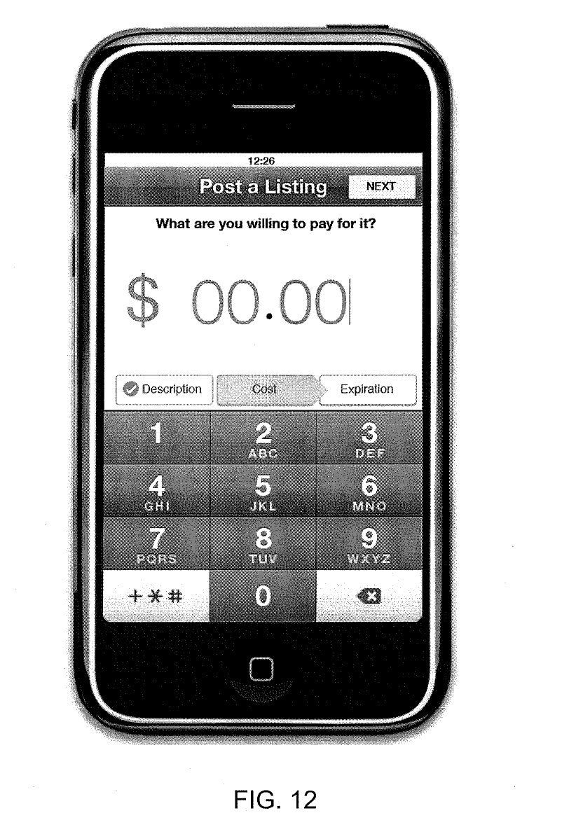

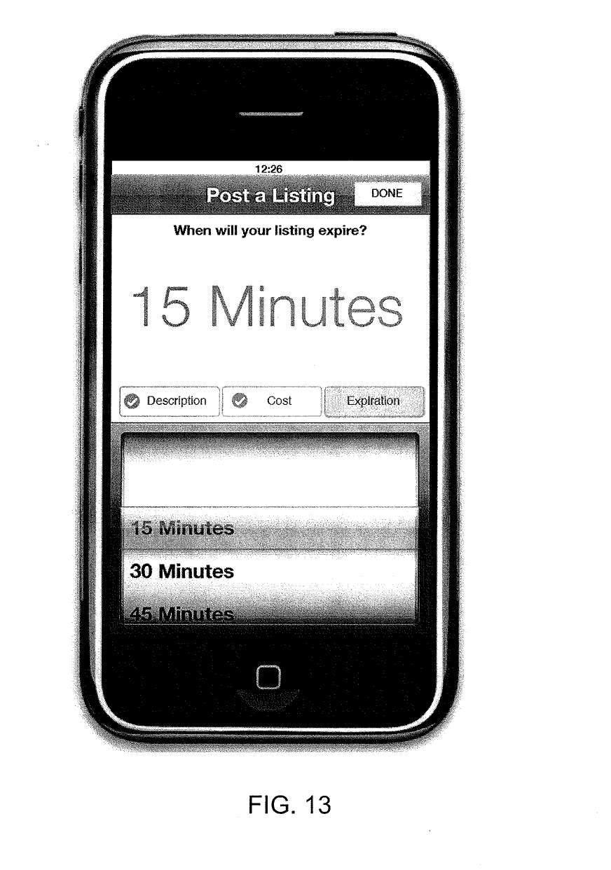

FIG. 2 illustrates an example of a listing process in accordance with one embodiment. In the embodiment illustrated in FIG. 2, client 100 can receive from user 102 a request to post a listing (block 200). The request to post a listing can include any information suitable to describe the listing, such as a description, cost and expiration. The description can include title information and description information corresponding to what user 102 may want as illustrated in the example user interface depicted in FIG. 11 that can be displayed on client 100. The cost can include a monetary amount corresponding to what user 102 may be willing to pay for it as illustrated in the example user interface depicted in FIG. 12 that can be displayed on client 100. The expiration can include a user selectable time period defining when the listing will expire as illustrated in the example user interface depicted in FIG. 13 that can be displayed on client 100. While the depicted user selectable time periods run in 15 minute increments (e.g., 15 minutes, 30 minutes, 45 minutes), any suitable time period can be utilized by system 120. System 120 can also implement a recommendation engine to recommend to posting users what price is likely to be successful on listings of certain subject matter based on a variety of information, such as prior transactions conducted in system 120, user specified interest channels, interests and listings specified as favorites by a user's friends.

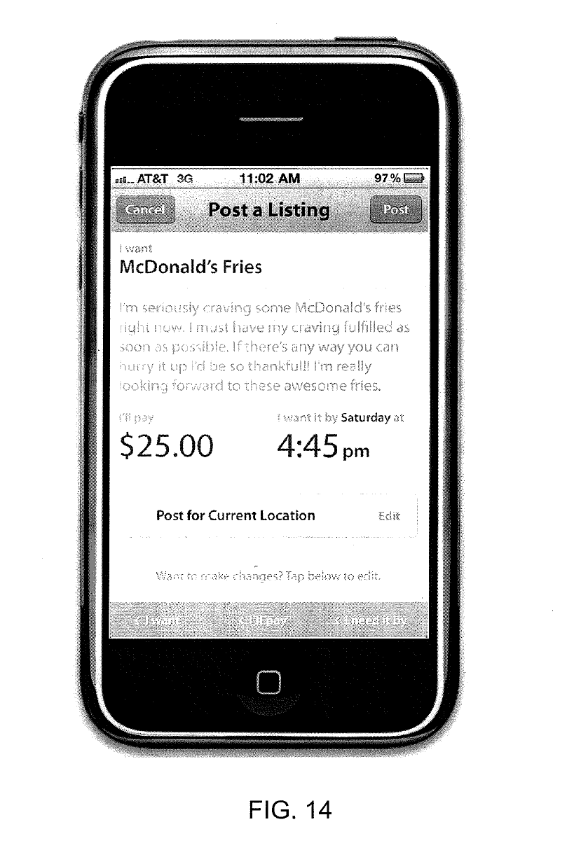

The request to post a listing can also include a location to be associated with the listing in system 120, such as the current location of client 100 or a location specified by user 102, such as an address. As illustrated in the example user interface depicted in FIG. 14 that can be displayed on client 100, the current location of client 100 can be specified upon selection of the indicated “Post for Current Location” option. Alternatively, a location entered by user 102, such as an address, can be provided upon selection of the “Edit” option adjacent to the “Post for Current Location” option.

In response to receiving the request to post the listing that includes the option to post for the current location, client 100 can detect its current location (block 210) using any suitable location detection mechanism. For example, in an embodiment in which client 100 has Global Positioning System (GPS) capability, client 100 can provide current location data obtained from GPS satellite signals in response to a query to its internal GPS chip. In another embodiment, client 100 can provide current location data in response to an API call to a geolocation-enabled web browser running on client 100, such as a web browser implementing the W3C Geolocation API. In another embodiment, client 100 can utilize the Internet Protocol (“IP”) address associated with its network connection to lookup current location data. In yet another embodiment, client 100 can utilize cell phone tower triangulation to obtain or estimate current location data. Upon detecting the current location, client 100 can submit the request to post the listing and the detected location data to system 120 (block 220).

Upon receiving the submitted data, system 120 can associate the detected location with the listing and post the listing (block 230) using any suitable posting mechanism. An example of a database record of a generic listing associated with a detected location at the White House can be:
{“listing”: {“description”: “this is what I'm looking for”, “price”: “25.00”, “latlng”: [123.0,456.0], “location”: “1600 Pennsylvania Ave, Washington D.C. 20001”, “time”: “2011-02-28T22:37:19Z”}}
which defines a listing associated with a description (“this is what I'm looking for”), price (“25.00”), location data using latitude and longitude coordinates (“[123.0,456.0]”), location (“1600 Pennsylvania Ave, Washington D.C. 20001”) and time (“2011-02-28T22:37:19Z”).

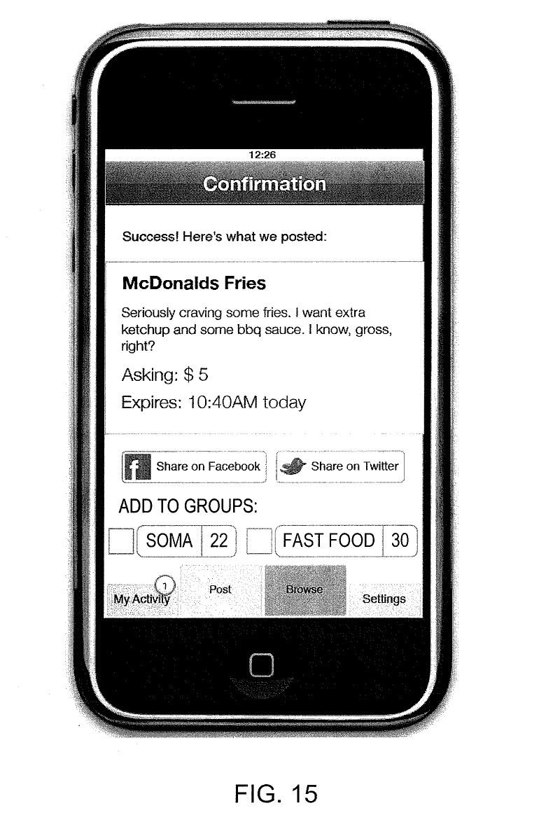

An example of a suitable posting mechanism includes storing the listing information in a database of listings so that it becomes available to users requesting to browse listings in system 120. Upon posting the listing, system 120 can provide user 102 with a confirmation of the posting as illustrated in the example user interface depicted in FIG. 15 that can be displayed on client 100. The confirmation can confirm the listing information as posted in system 120 and provide additional options for user 102 to notify others about the listing.

The additional notification options can include group-based notifications. In particular, system 120 can provide to client 100 an indication of groups in system 120 within a proximity of the received detected location (block 240). In one embodiment, system 120 can identify these groups by defining an area, such as search radius 130, around the detected location and identifying any group in system 120 that is associated with location data representing a location within the defined area. The area defined by system 120 can include any suitable proximity to the detected location, such as a proximity predetermined by system 120 (e.g., 20 miles from the detected location) or a proximity requested by client 100 as part of the request to post the listing (e.g., 5 miles from the detected location). As illustrated in the example user interface depicted in FIG. 15, the group labeled “SoMa” (representing a neighborhood in San Francisco and associated with location data in system 120) depicts an example of a group that can be provided by system 120 within a proximity of the received detected location.

System 120 can also provide client 100 with an indication of groups that lack any association in system 120 with location data but may pertain to the subject matter of the listing. In one embodiment, system 120 can identify these groups by performing a natural language search of the descriptions associated with the groups using the description associated with the listing as a query. The groups meeting or exceeding a particular confidence score as a result of the search can be provided by system 120 to client 100. As illustrated in the example user interface depicted in FIG. 15, the group labeled “Fast Food” (representing an interest in fast food and lacking an association with location data in system 120) depicts an example of a group that can be provided by system 120 without an association in system 120 with location data but pertaining to the subject matter of the listing (i.e., McDonalds Fries).

Upon receiving the indication of groups, client 100 can display the indication of groups and receive from user 102 a selection, if any, of the provided groups to notify of the listing (block 250). As illustrated in the example user interface depicted in FIG. 15, each of the provided groups is displayed adjacent to a check box, depicted as an empty square, that user 102 can click to evidence a selection. System 120 can also provide a number to be displayed with the groups indicating how many users are associated with the group, since the number of members or followers of a group may influence user 102's decision to select that group. As illustrated in the example user interface depicted in FIG. 15, the number “22” displayed with the group labeled “SoMa” can indicate that the “SoMa” group has 22 members or followers. Similarly, the number “30” displayed with the group labeled “Fast Food” can indicate that the “Fast Food” group has 30 members or followers.

Upon receiving the selection of groups from client 100, system 120 can push the listing to each member or follower of the selected groups (block 260). In one embodiment, system 120 can push the listing to the members or followers by using the contact information they provided when creating their account with system 120, such as via e-mail and/or Short Message Service (SMS). System 120 can also push the listing to the members or followers by using any suitable instant messaging platform, such as the Apple Push Notification (“APN”) Server in embodiments in which the functionality of client 100 described herein is implemented by a software application downloaded from system 120 and client 100 constitutes a phone such as an iPhone® manufactured by Apple Inc. or the Cloud to Device Messaging (“C2DM”) service in embodiments in which the functionality of client 100 described herein is implemented by a software application downloaded from system 120 and client 100 constitutes a phone that runs the Android® operating system manufactured by Google Inc.

The additional notification options can also include system 120 pushing the listing onto a different online system, such as a social networking site, with which user 102 is associated. Upon receiving an indication of different online system on which user 102 requests to share the listing, system 120 can request user 102's login information for the indicated system, such as username and password, and log in to the site on user 102's behalf and post the listing in a manner enabled by the indicated system.

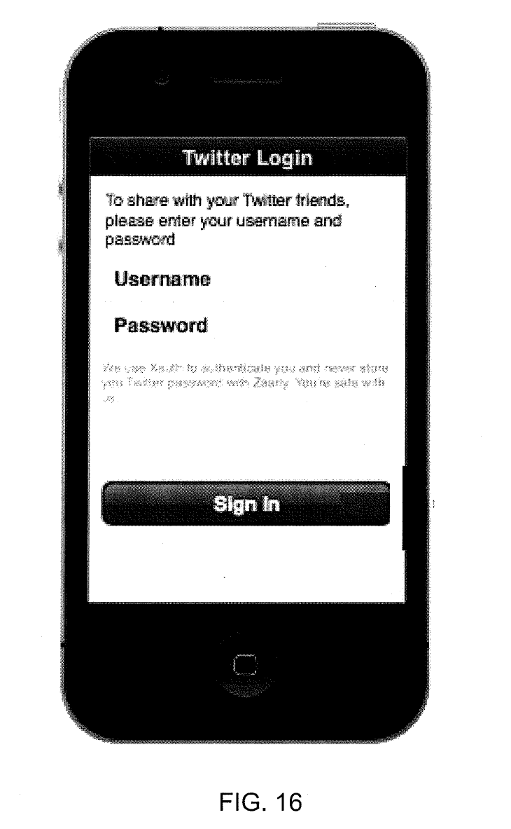

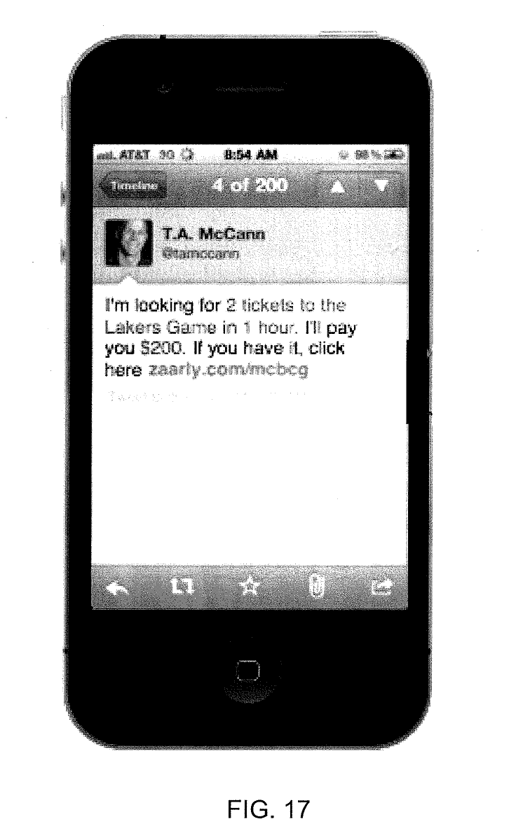

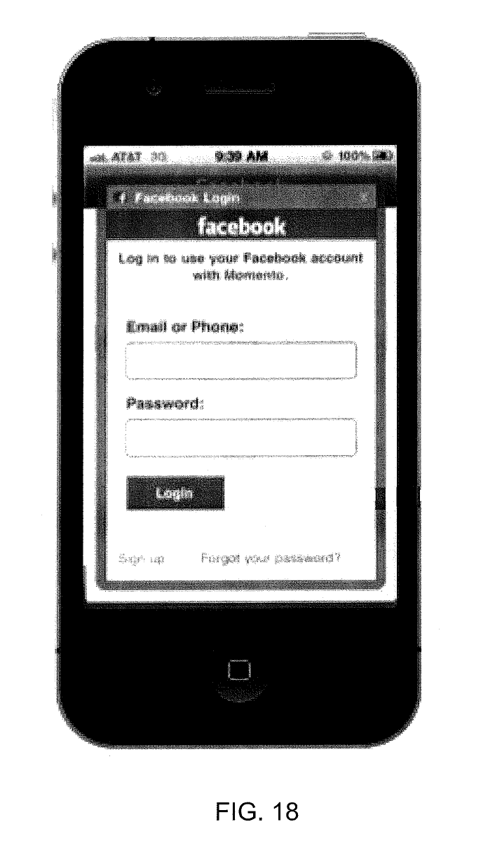

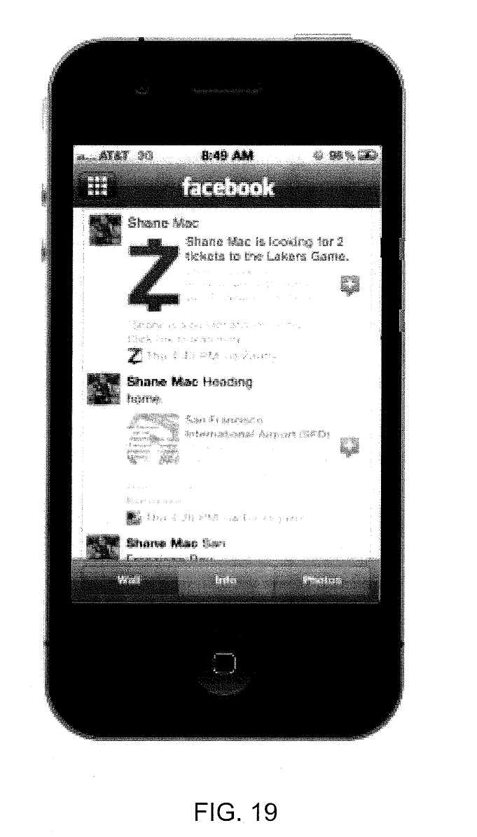

For example, as illustrated in the example user interface depicted in FIG. 15, client 100 can display an indication of one or more different online systems, such as Facebook® and Twitter®, on which user 102 can choose to share the listing. Upon selection of the Twitter® icon, system 120 can cause the example user interface depicted in FIG. 16 to be displayed on client 100 requesting user 102's login information for Twitter®, and upon receipt of the login information, post the listing on Twitter® in a manner similar to the different listing illustrated in the example user interface depicted in FIG. 16 as displayed on client 100. Similarly, upon selection of the Facebook® icon, system 120 can cause the example user interface depicted in FIG. 18 to be displayed on client 100 requesting user 102's login information for Facebook®, and upon receipt of the login information, post the listing on Facebook® in a manner similar to the different listing illustrated in the example user interface depicted in FIG. 19 as displayed on client 100.

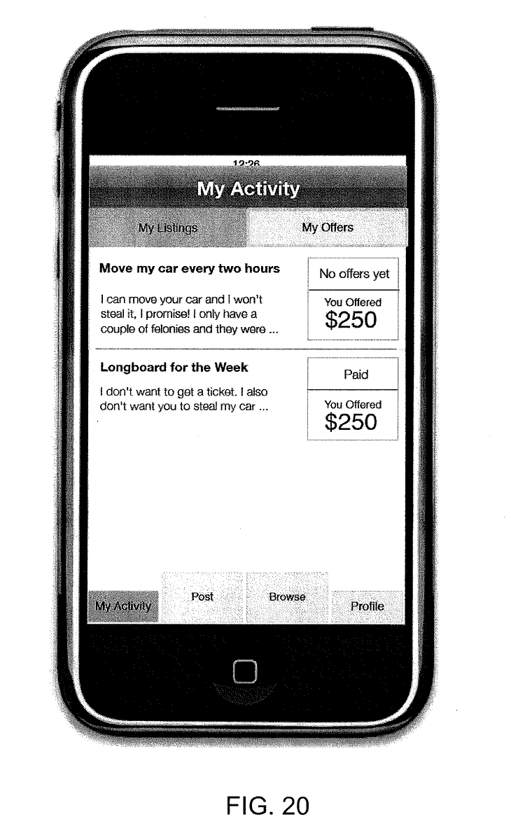

System 120 can also provide via client 100 a summary view of activity associated with user 102's listings, as illustrated by the “My Listings” screen in the example user interface depicted in FIG. 20. For example, the summary view of activity on user 102's listings can include identifying whether any offers have been made on user 102's posted listings and whether user 102 has completed payment on any of user 102's posted listings.

It is noted that in an embodiment in which the location associated with a listing is entered by a user rather than detected by a client, the functionality described above in connection with blocks 230-260 can be similarly applied to the entered location rather than the detected location of the listing.

In connection with browsing listings, when user 112 submits a request to browse listings on system 120 from client 110, system 120 can similarly utilize location data (such as latitude and longitude) from client 110 to define a search radius (not shown) around user 112's location. Although this search radius is not shown, it is similar to search radius 130 but centered on client 110 and encompasses client 100 and user 102. System 120 can subsequently provide listings that are associated with a location within the search radius.

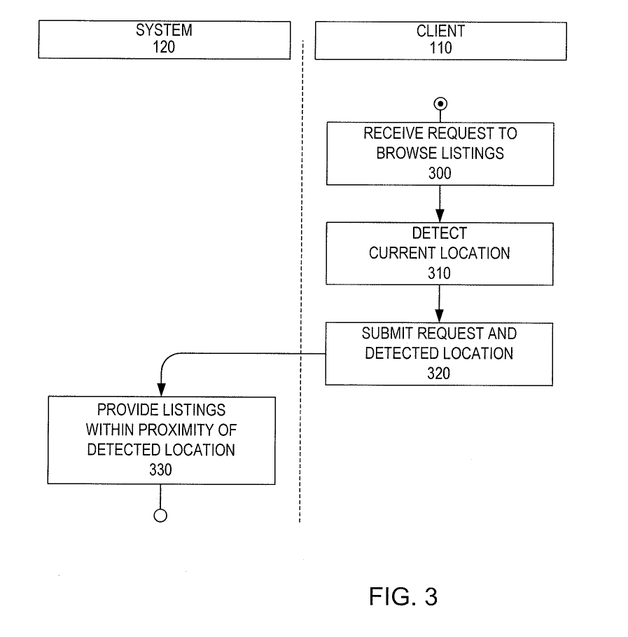

FIG. 3 illustrates an example of a browsing process in accordance with one embodiment. In the embodiment illustrated in FIG. 3, client 110 can receive from user 112 a request to browse a listing (block 300). The request to browse a listing can include user 112 selecting an option to browse listings on system 120 that is displayed on client 110. The option to browse listings can be displayed on client 110 in a manner similar to the display of the “Browse” tab at the bottom of the example user interface depicted in FIG. 15. In response to receiving the request to browse listings, client 110 can detect its current location (block 310) using any suitable location detection mechanism, including those described above in connection with block 210. Upon detecting the current location, client 110 can submit the request to browse listings and the detected location data to system 120 (block 320). Upon receiving the submitted data, system 120 can provide to client 110 an indication of listings in system 120 within a proximity of the received detected location (block 330).

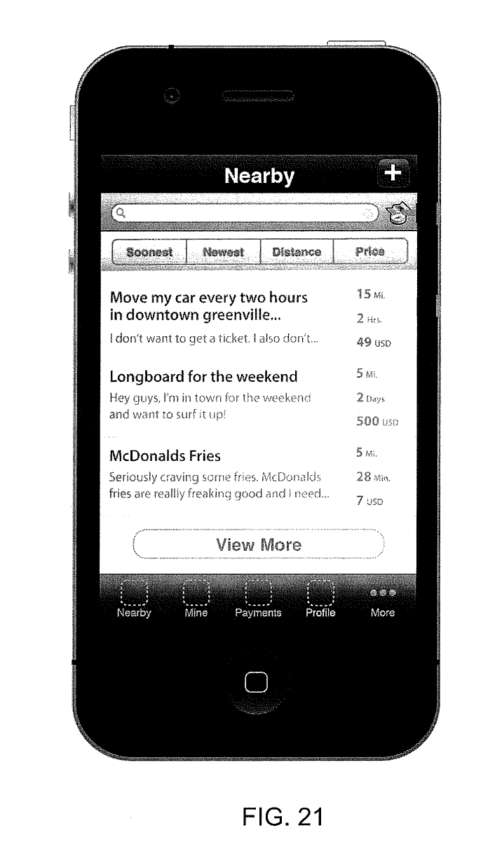

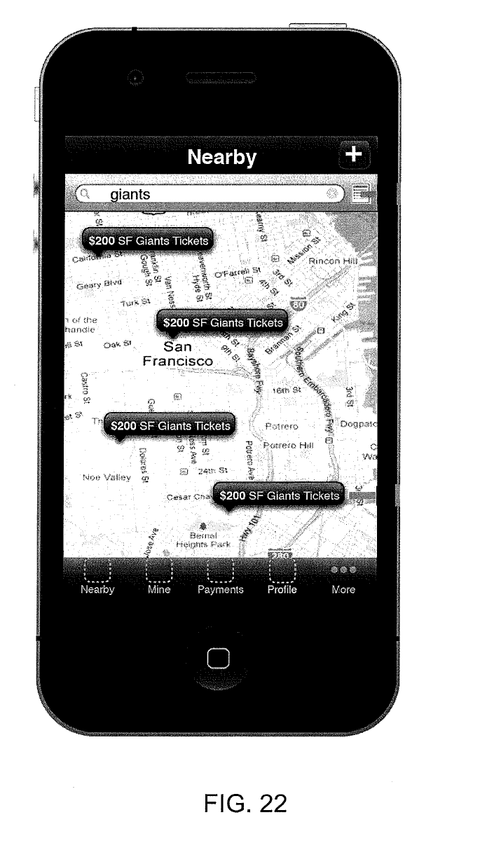

In one embodiment, system 120 can identify these listings by defining an area around the detected location and identifying any listing in system 120 that is associated with location data representing a location within the defined area. Similar to block 240 described above, the area defined by system 120 can include any suitable proximity to the detected location, such as a proximity predetermined by system 120 (e.g., 20 miles from the detected location) or a proximity requested by client 110 as part of the request to browse listings (e.g., 5 miles from the detected location). As illustrated in the example user interface depicted in FIG. 21, the nearby listings can be provided in any suitable manner, such as in a list view for browsing on client 110 by the soonest listings, by the newest listings, by distance to the detected location, and by price. The listings can also be filtered by a search query that can be entered by user 112 in the search bar at the top of the user interface. As illustrated in the example user interface depicted in FIG. 22, the nearby listings may also be provided for browsing on client 110 in a geospatial manner, such as in a map view. In the map view, each of the displayed listings can be identified by a marker such as a pin or balloon. The marker can also indicate a price and description associated with the respective listing. The listings can also be filtered by a search query that can be entered by user 112 in the search bar at the top of the user interface.

System 120 can also improve the efficiency with which buyers and sellers can quickly find each other by not allowing users to submit offers on listings with price changes that degrade the listing. This enforces the notion that users who post listings are willing to pay a premium for an item or service, or sell an item or service at a discount, for quicker action on the listing or better service offered in response to the listing.

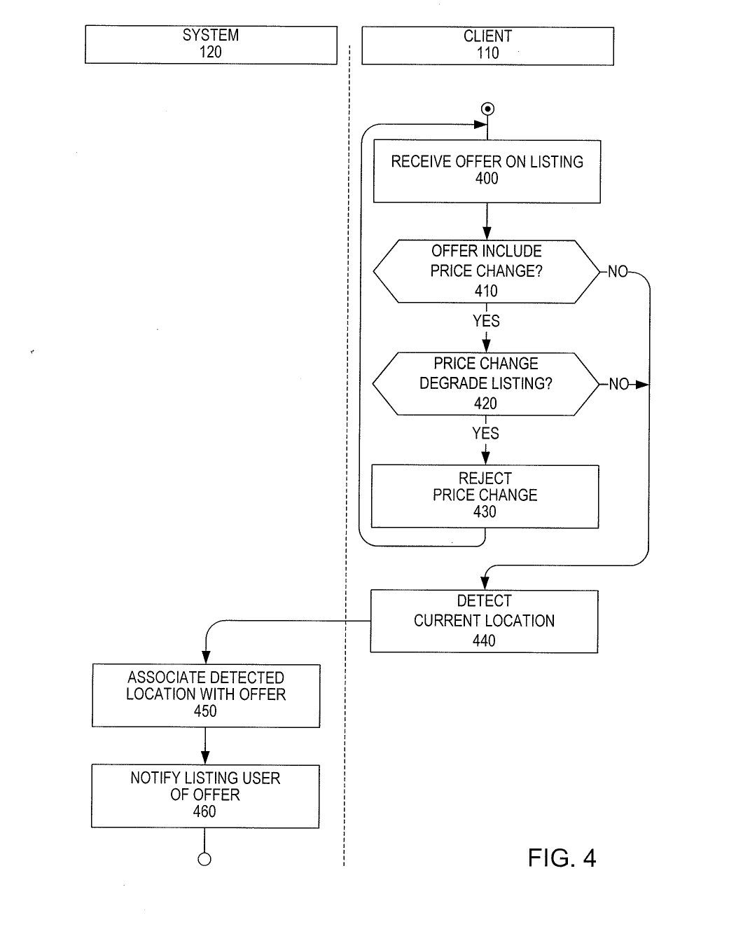

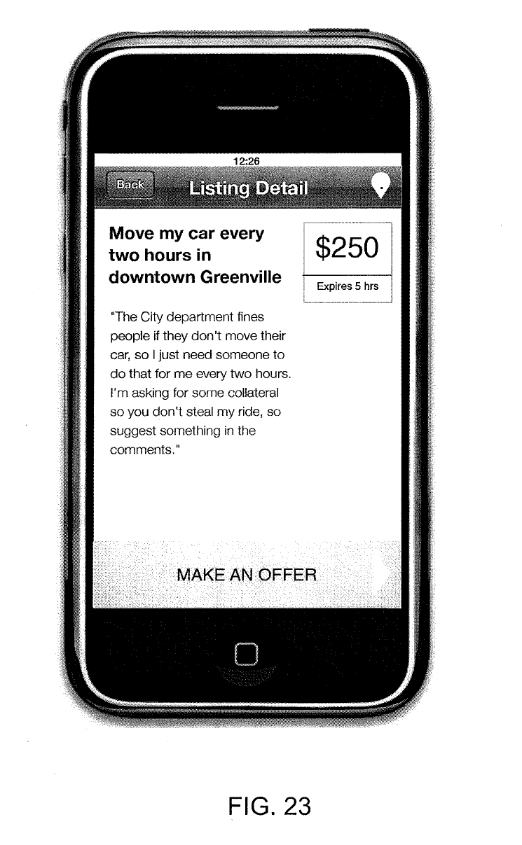

FIG. 4 illustrates an example of a bidding process in accordance with one embodiment. For purposes of the embodiment illustrated in FIG. 4, presume user 102, participating as a buyer, has posted a listing indicating that user 102 is willing to pay a certain price for a certain service to be performed. Upon user 112, participating as a seller, browsing and selecting this listing, client 110 can display user interfaces, as illustrated in the example user interfaces depicted in FIGS. 23-26, to receive from user 112 an offer to perform the indicated service (block 400).

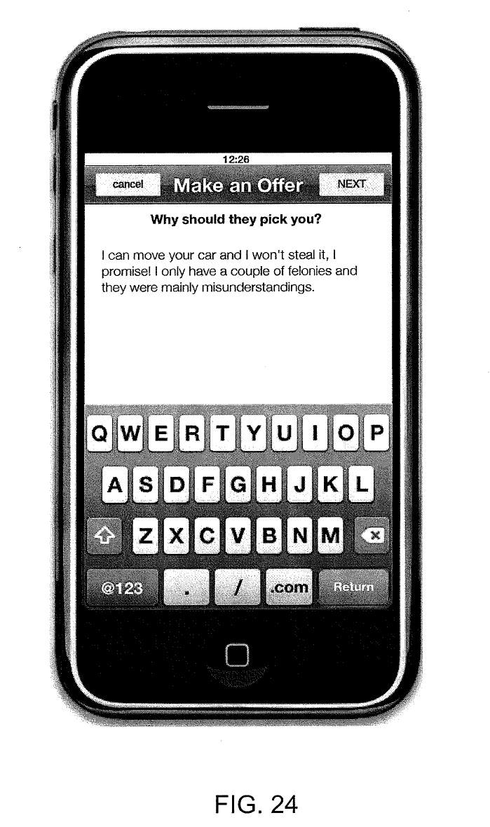

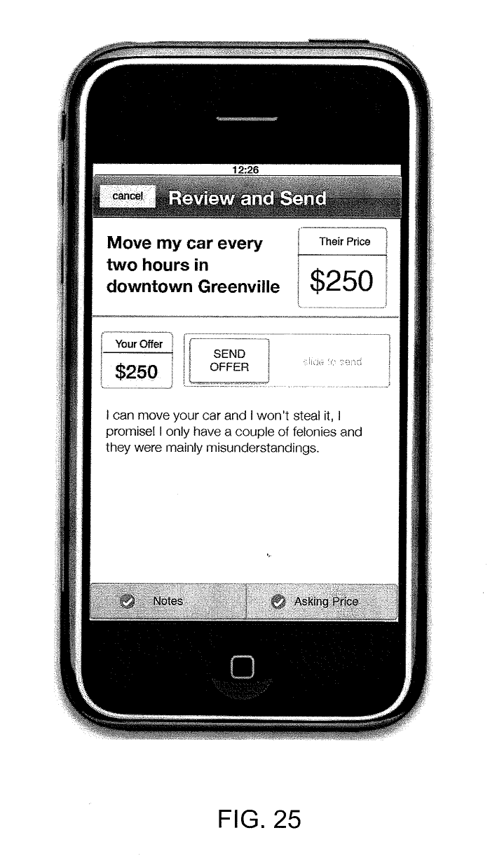

As illustrated in the example user interface depicted in FIG. 23, client 110 can display a user interface to provide user 112 with an option to make an offer on the selected listing, such as by tapping the depicted “Make an Offer” button. As illustrated in the example user interface depicted in FIG. 24, client 110 can display a user interface to allow user 112 to enter a message to be associated with the offer. This message may explain, for example, why user 102 may want to choose user 112's offer over another user's offer. As illustrated in the example user interface depicted in FIG. 25, client 110 can display a user interface that allows user 112 to review and send the offer. To prevent an inadvertent sending of the offer due to an inadvertent tap of the screen, the user interface can provide a slider control to send an offer, such as the “Send Offer” control depicted in FIG. 25 that can require user 112 to tap and drag the control to complete command to send the offer.

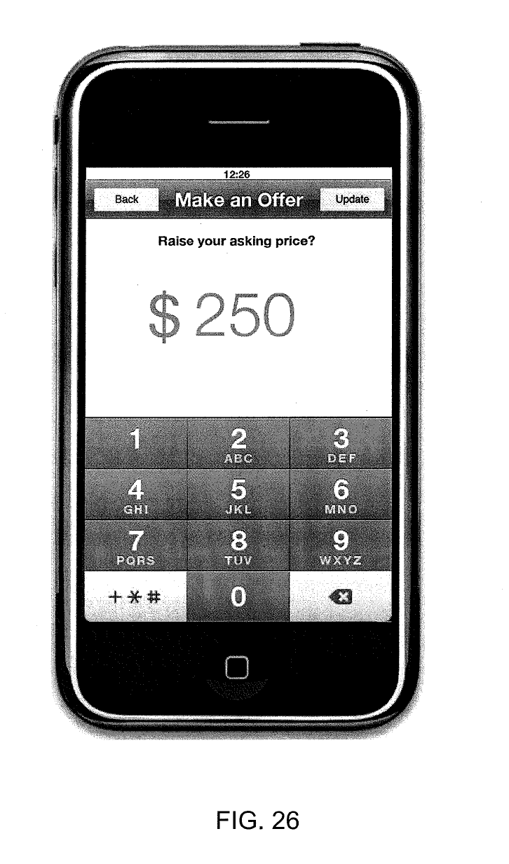

Client 110 can also display a user interface to provide user 112 with an option to indicate a price that is different from user 102's indicated price (block 410). As illustrated in the example user interface depicted in FIG. 26, user 112 can be provided with an opportunity to raise the price associated with the listing by entering a higher price. If the user 112's entered price is less than user 102's indicated price, client 110 can determine that user 112's price degrades (block 420) user 102's listing and can reject (block 430) the price change. Conversely, if user 112's price is more than user 102's indicated price, client 110 can determine that user 112's price does not degrade (block 420) user 102's listing and allow the offer to proceed.

It is noted that in a situation in which user 102 participates as a seller (i.e., user 102 has posted a listing indicating that user 102 is willing to sell a certain item or service for a certain price) and user 112 participates as buyer (i.e., user 112 submits an offer to pay for the item or service indicating a different price), client 110 can determine that user 112's price degrades user 102's listing if user 112's price is more than user 102's indicated price, and client 110 can determine that user 112's price does not degrade user 102's listing if user 112's price is less than user 102's indicated price.

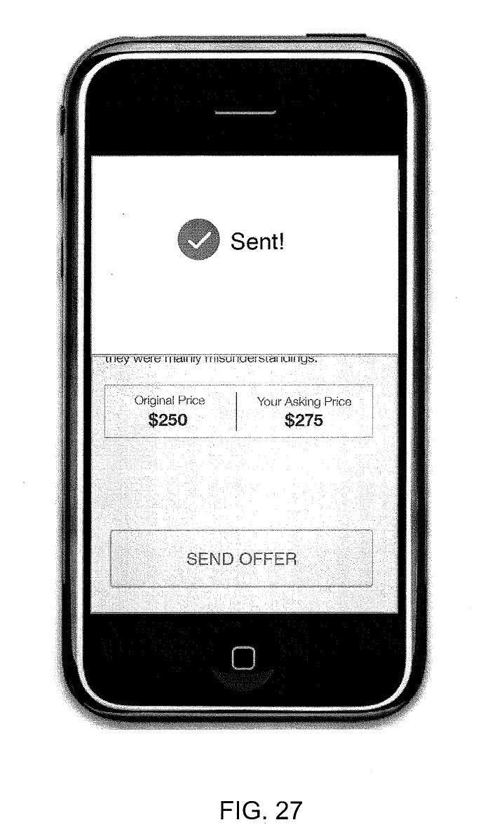

Upon proceeding with the offer, client 110 can detect its current location (block 440) using any suitable location detection mechanism, including those described above in connection with block 210. Upon detecting the current location, client 110 can submit the offer and the detected location data to system 120 and notify user 112 that the offer has been sent as illustrated in the example user interface depicted in FIG. 27.

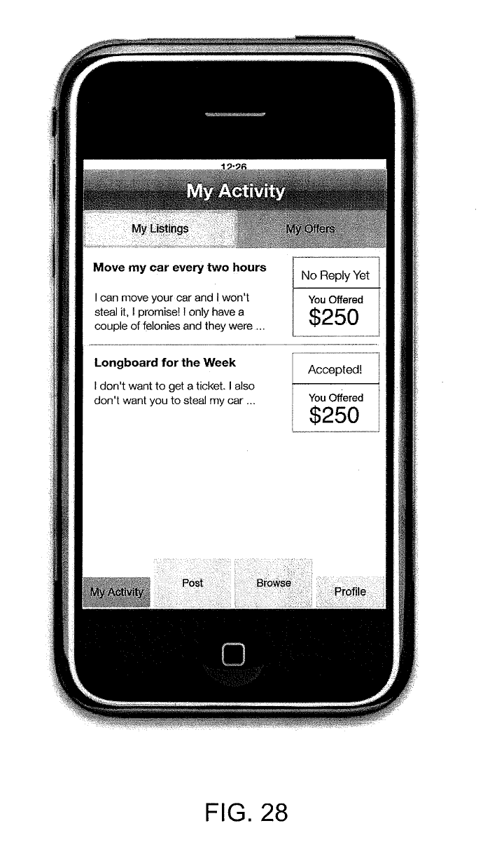

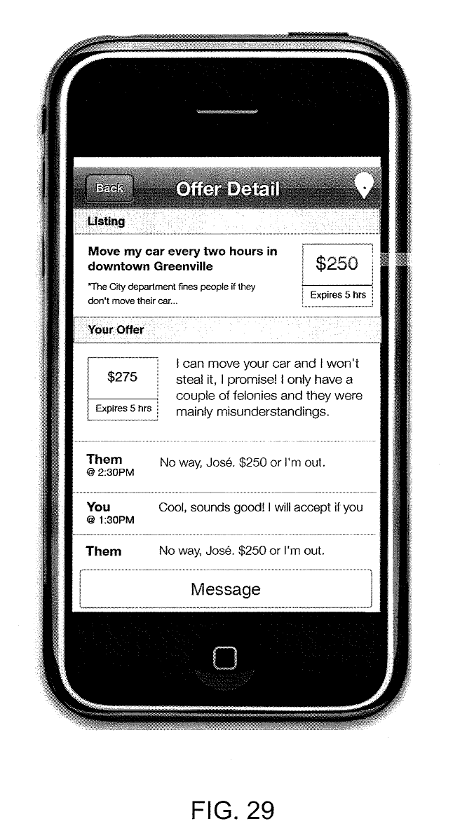

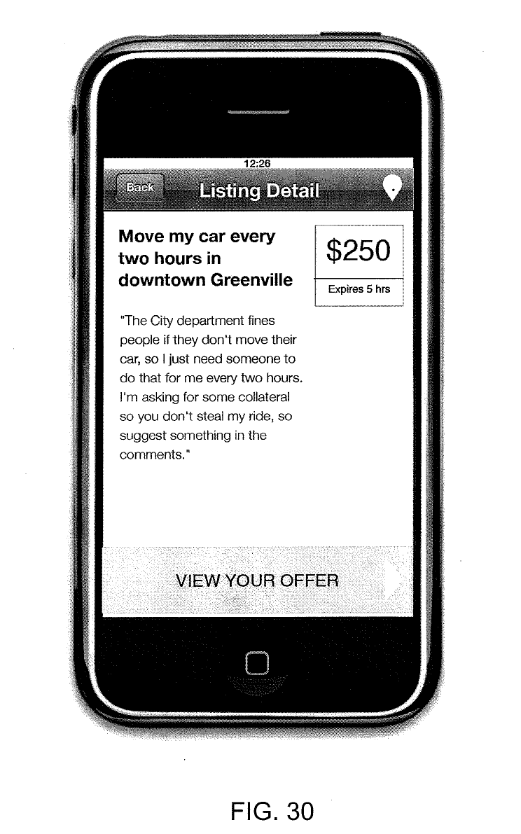

System 120 can also provide via client 110 a summary view of activity associated with user 112's offers, as illustrated by the “My Offers” screen in the example user interface depicted in FIG. 28. For example, the summary view of activity on user 112's offers can include identifying whether any of user 112's offers have received replies and whether any of user 112's offers have been accepted. Upon selection of an offer in the summary view by user 112, client 110 can display a user interface to provide a detailed view of the selected offer, including, for example, a listing area describing the listing and an offer area describing the offer, as illustrated in the example user interface depicted in FIG. 29. Upon receiving an input such as a tap by user 112 in the listing area, client 110 can display a user interface to provide a detailed view of the selected listing, as illustrated in the example user interface depicted in FIG. 30.

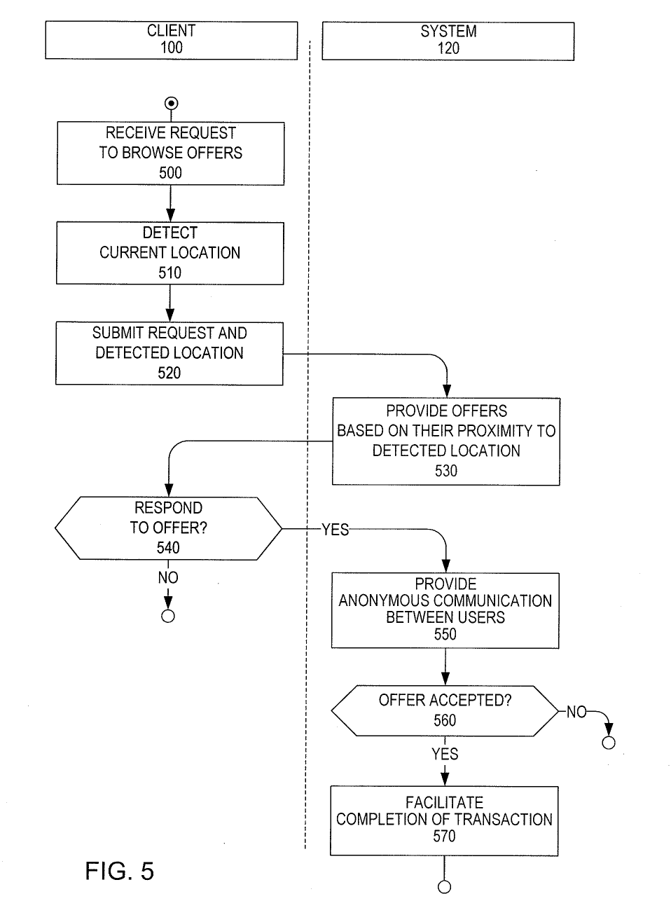

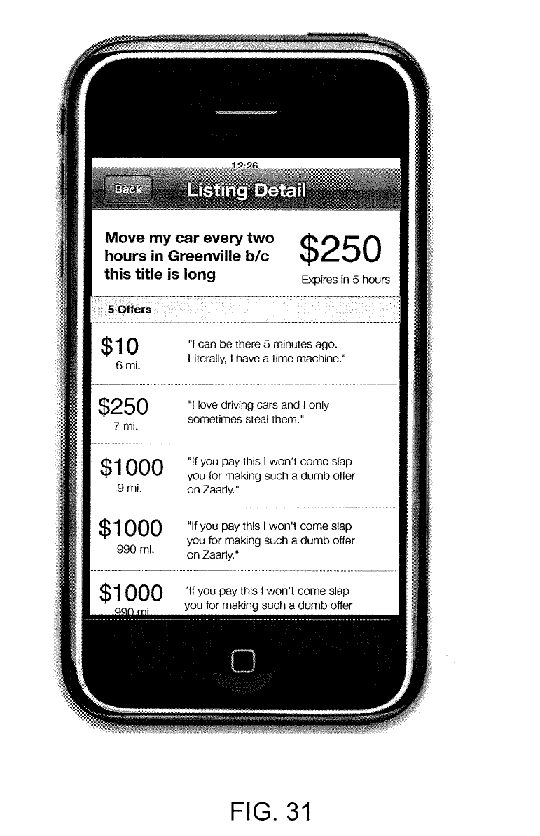

Upon receiving the offer and the detected location data from client 110, system 120 can associate the detected location with the offer (block 450) and notify user 102 of the offer (block 460) as illustrated in the example user interface depicted in FIG. 31. The notification to user 102 can be provided by system 120 by using the contact information user 102 provided when creating the account with system 120, such as via e-mail and/or Short Message Service (SMS), and/or by pushing the notification to user 102 via any suitable instant messaging platform as described above. By associating the detected location with the offer, system 120 can provide nearby offers to user 102 for browsing as illustrated in FIG. 5.

FIG. 5 illustrates an example of an offer consideration and acceptance process in accordance with one embodiment. In the embodiment illustrated in FIG. 5, client 100 can receive from user 102 a request to browse offers on user 102's listings (block 500). The request to browse offers can include user 102 selecting an option to browse offers on one or more of user 102's listings displayed on client 100 such as in the example user interface depicted in FIG. 20. In response to receiving the request to browse offers, client 100 can detect its current location (block 510) using any suitable location detection mechanism, including those described above in connection with block 210. Upon detecting the current location, client 100 can submit the request to browse offers and the detected location data to system 120 (block 520). Upon receiving the submitted data, system 120 can provide to client 100 an indication of offers responsive to one or more of user 102's listings in system 120 based on their proximity to the received detected location (block 530).

For example, in one embodiment system 120 can identify these offers sorted by location nearest the detected location, such as in the manner illustrated in the example user interface depicted in FIG. 31. In another embodiment, system 120 can identify these offers by defining an area around the detected location and identifying any offer that is responsive to one of user 102's listings in system 120 and is associated with location data representing a location within the defined area. Similar to block 240 described above, the area defined by system 120 can include any suitable proximity to the detected location, such as a proximity predetermined by system 120 (e.g., 20 miles from the detected location) or a proximity requested by client 100 as part of the request to browse offers (e.g., 5 miles from the detected location). The nearby listings can be provided in any suitable manner, such as a list view for browsing on client 100 by the soonest offers, by the newest offers, by distance to the detected location, and by price in a manner similar to the example user interface depicted in FIG. 21. The offers can also be filtered by a search query that can be entered by user 102 in the search bar at the top of the user interface. The nearby listings may also be provided for browsing on client 110 in a geospatial manner, such as in a map view in a manner similar to the example user interface depicted in FIG. 22. In the map view, each of the displayed offers can be identified by a marker such as a pin or balloon. The marker can also indicate a price and description associated with the respective offer. The offers can also be filtered by a search query that can be entered by user 102 in the search bar at the top of the user interface.

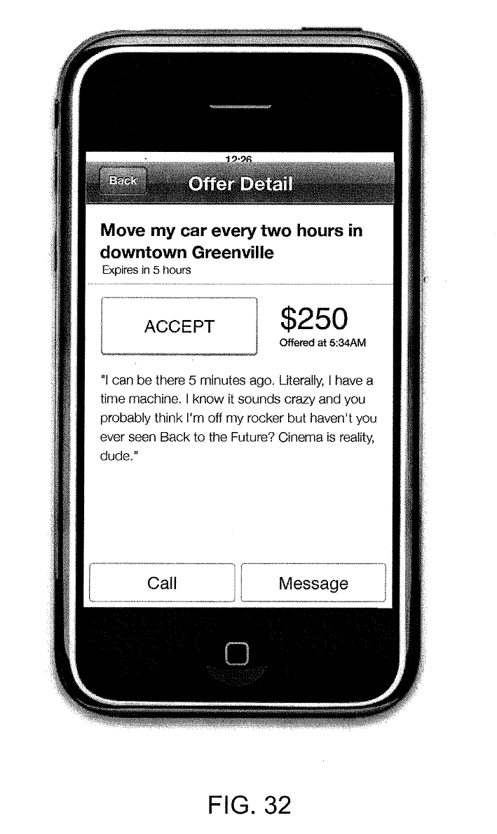

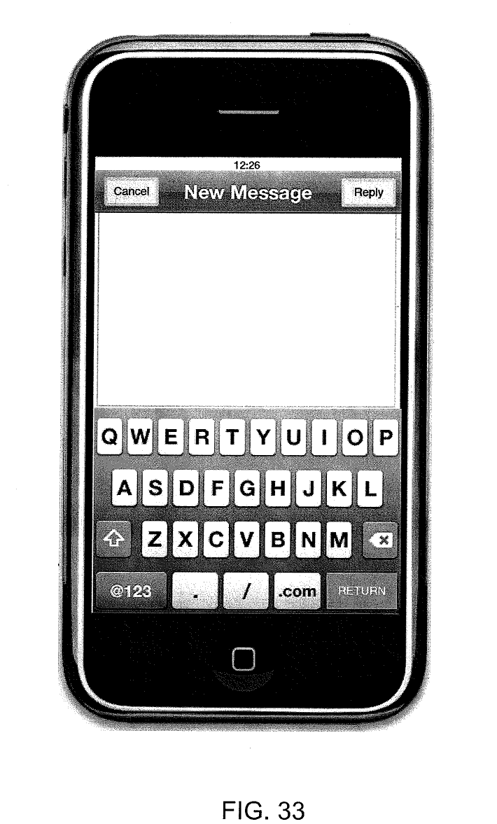

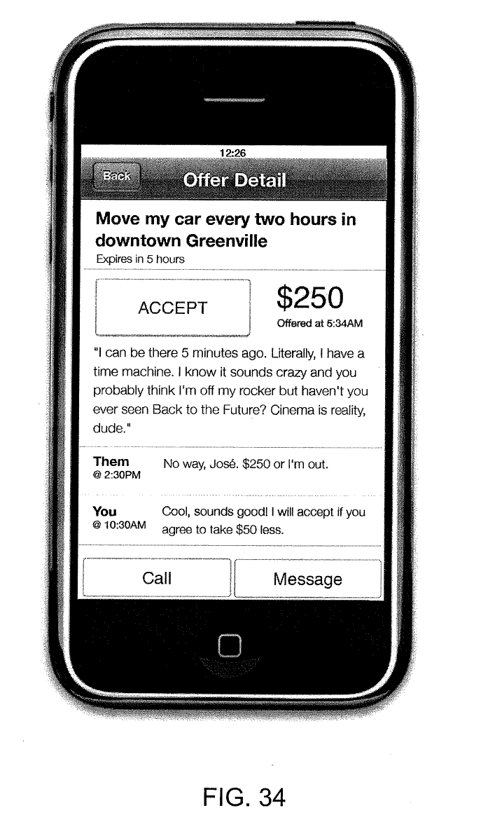

Upon selecting a particular offer to view, client 100 can display a detailed view of the selected offer as illustrated in the example user interface depicted in FIG. 32. If user 102 chooses to respond to the offer (block 540), system 120 can facilitate further communication between user 102 and user 112 in an anonymous manner (block 550). For example, system 120 can act as an intermediary in communications such as e-mail, SMS and/or instant messaging between user 102 and user 112. In particular, system 120 can configure each communication from user 102 to user 112 and from user 112 to user 102 to be addressed to and relayed by system 120 in a non-identifying manner, such as by using unique identifiers representing each party. FIG. 33 depicts an example user interface in which user 102 can enter an anonymous message to be provided to user 112, and FIG. 34 depicts an example user interface displaying an anonymous conversation between user 102 (identified by “You”) and user 112 (identified by “Them”). System 120 can also facilitate an anonymous phone communication between user 102 and user 112 as illustrated by the “Call” option depicted in the example user interfaces depicted in FIGS. 32 and 34. Such communication can be implemented by using a third party web service such as Twilio® to connect the callers in an anonymous manner.

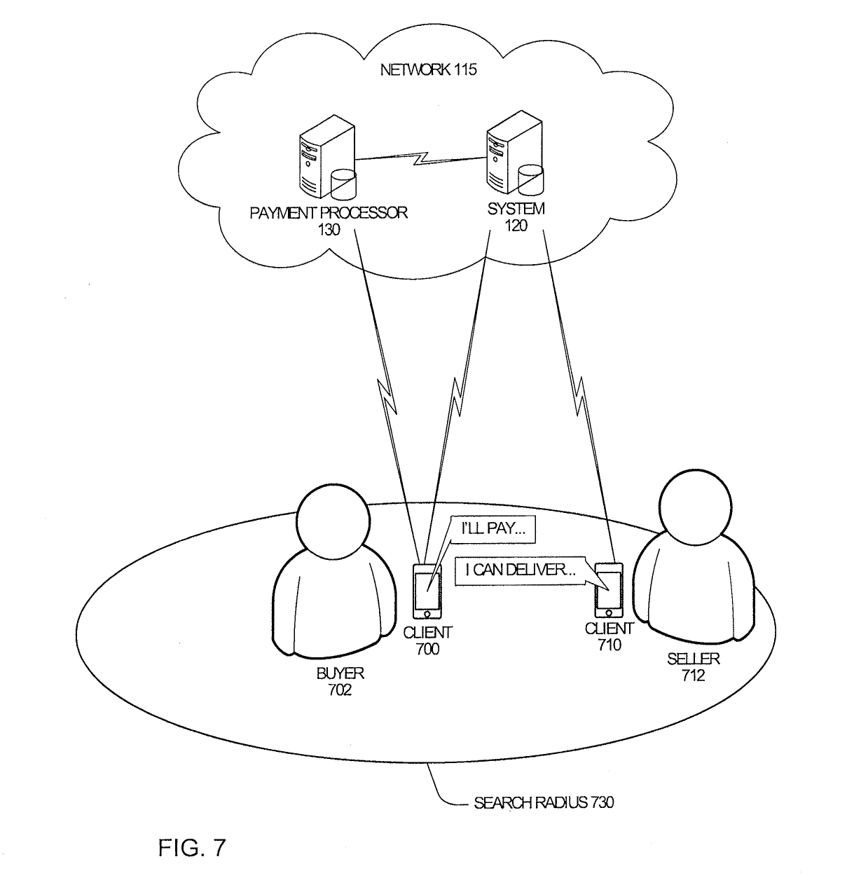

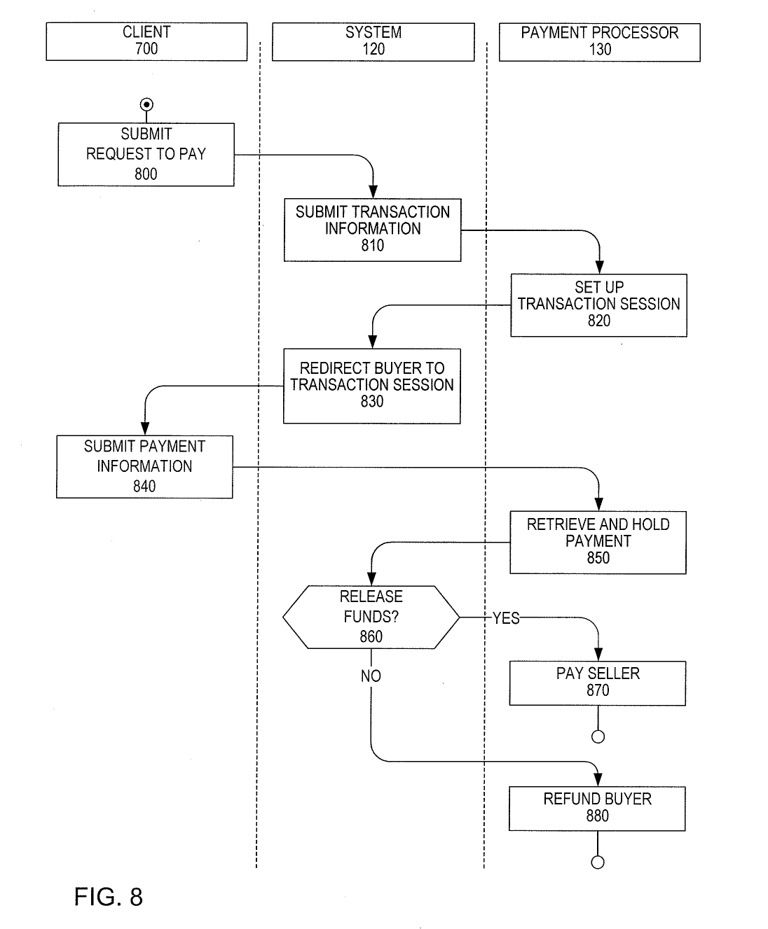

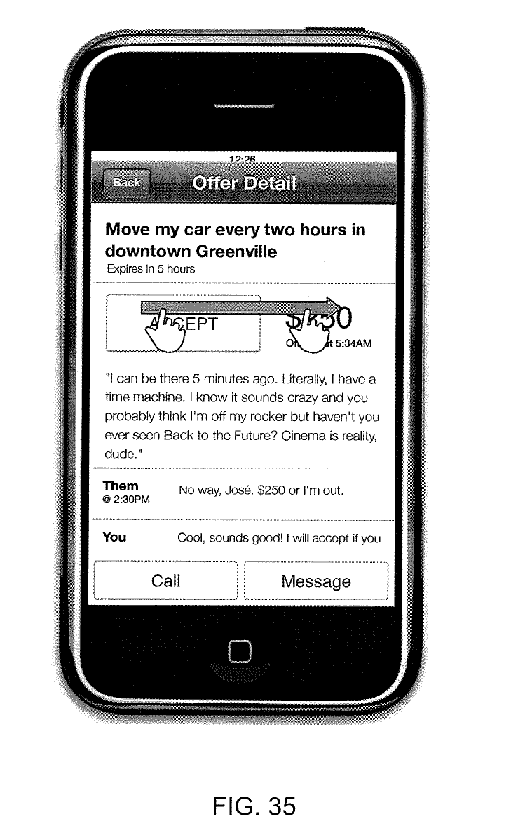

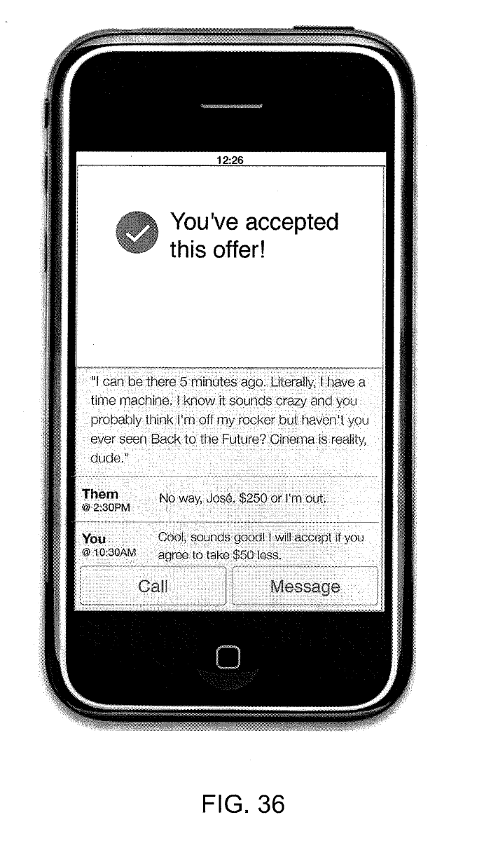

As illustrated in the example user interface depicted in FIG. 35, client 100 can display a user interface to allow user 102 to accept the offer. To prevent an inadvertent acceptance of the offer due to an inadvertent tap of the screen, the user interface can provide a slider control to accept the offer, such as the “Accept” control depicted in FIG. 35 that can require user 102 to tap and drag the control to complete command to accept the offer. Upon acceptance of the offer (block 560), client 100 can notify user 102 that the offer has been accepted as illustrated in the example user interface depicted in FIG. 36 and system 120 can facilitate completion of the transaction (block 570), such as described in connection with FIGS. 7 and 8. In an alternative embodiment, system 120 can be configured by user 102 to auto-accept the first offer made on user 102's listing.

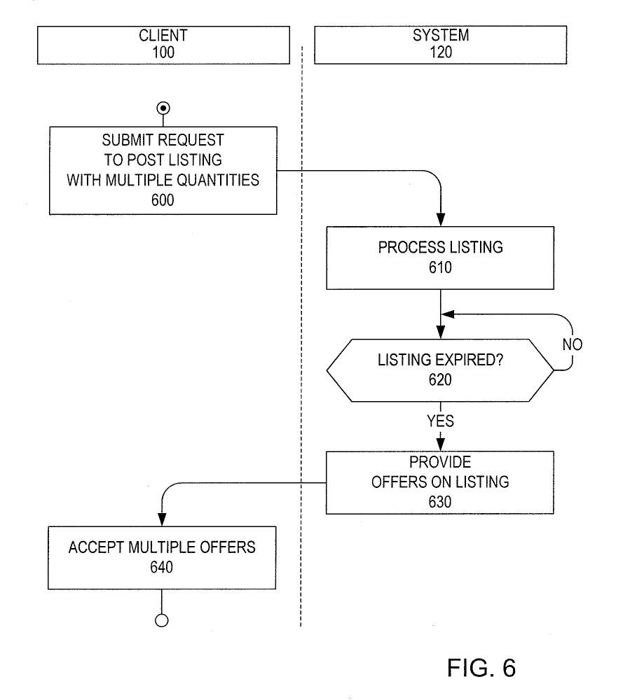

In another embodiment, system 120 can allow listings to define multiple quantities of an item or service and allow multiple offers to be made and accepted on such listings. FIG. 6 illustrates an example of a process for a listing having multiple quantities in accordance with this embodiment. For purposes of the embodiment illustrated in FIG. 6, presume user 102, participating as a seller, desires to post a listing indicating that user 102 has X amount of an item with a value of $Y. Client 100 can provide a user interface similar to the user interfaces described in connection with FIGS. 11-13 and including a field to allow user 102 to indicate a quantity of the item to sell. Upon receiving from user 102 a request to post a listing that includes the quantity of the item that user 102 desires to sell, client 100 can submit the request to post the listing with the quantity information (block 600) to system 120. Upon receiving the request, system 120 can process the listing into system 120 (block 610) in any suitable manner, such as in the manner described above in connection with blocks 230-260. When the listing expires (block 620), system 120 can provide the offers on the listing (block 630) to client 100, which can allow user 102 to accept multiple offers (block 640) for the listing. In a further embodiment, system 120 can be configured to accept multiple offers on the listing on user 102's behalf in accordance with an auction format.

In an example of the auction format, a seller can provide a listing on system 120 indicating the seller has X of an item with a value of $Y. Buyers can respond to the listing by making offers indicating what they would pay for the item. The seller can subsequently accept the buyers' offers that have the highest X prices. To facilitate the seller's acceptances of offers, system 120 can provide to seller the offers sorted by price or any other feature, so that seller may easily select the desired buyers' offers to accept. Alternatively, system 120 can automatically accept the highest offers on the seller's behalf up to the quantity indicated in the listing.

System 120 can also improve the efficiency with which buyers and sellers complete their transaction by facilitating a peer-to-peer payment process with dispute resolution controls.

FIG. 7 illustrates an example of a network architecture in accordance with one embodiment. The embodiment of FIG. 7 generally corresponds to that of FIG. 1 with the addition of payment processor 130, which can be a third party payment processor or a payment processor that is part of system 120. To provide context for the embodiment that follows, buyer 702 can represent an operator of client 700 and seller 712 can represent an operator of client 710. Buyer 702 can use client 700 to post a listing on system 120 indicating what buyer 702 wants to buy. Seller 712 can use client 710 to respond to the listing, indicating that seller 712 can deliver what buyer 702 wants to buy.

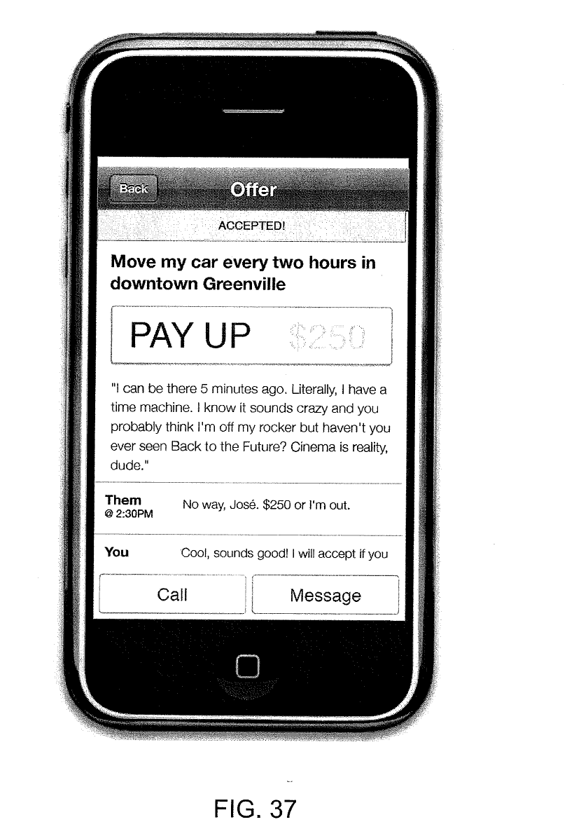

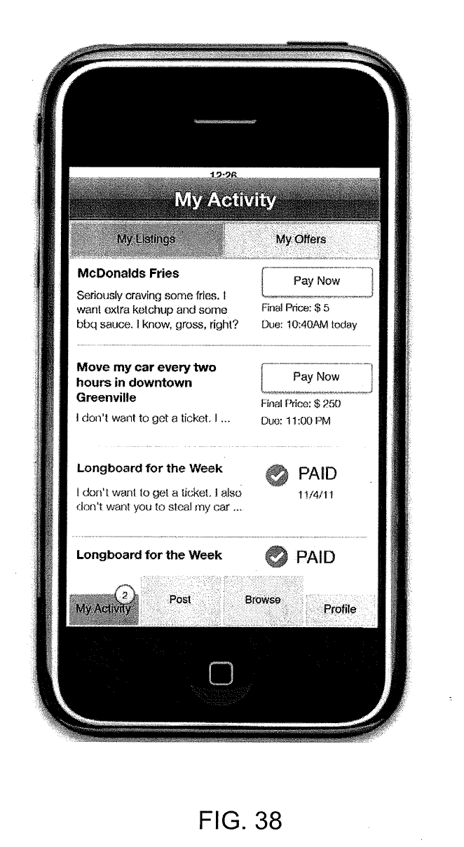

FIG. 8 illustrates an example of a payment process in accordance with one embodiment. In response to buyer 702 submitting a request to pay seller 712 on the listing (block 800), such as by actuating the “Pay Up” slider control after accepting an offer in the example user interface depicted in FIG. 37 or by clicking the “Pay Now” button in buyer 702's summary view of listings in the example user interface depicted in FIG. 38, system 120 can submit transaction information (block 810) to payment processor 130 on buyer 702's behalf to enable payment processor 130 to setup a transaction session (block 820) for buyer 720. The transaction information can include any information held by system 120 that can facilitate the setting up of the transaction, such as the buyer's name, contact information and transaction amount.

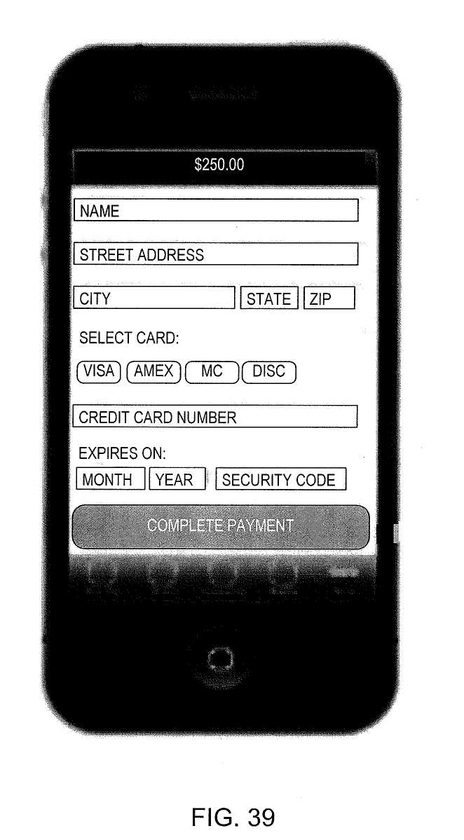

Once payment processor 130 has setup the transaction session, payment processor 130 can send a session identifier to system 120. In response, system 120 can use the session identifier, such as in a URL redirect to client 700, to redirect client 700 to the transaction session to provide payment information (block 830). An example of a transaction session is illustrated in the example user interface depicted in FIG. 39.

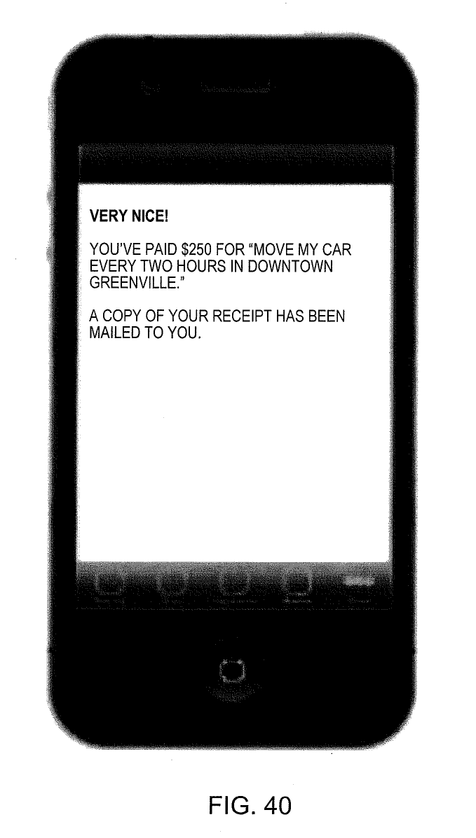

In response to buyer 702 submitting payment information (block 840), such as credit card information or information authorizing buyer 702's phone to be charged, to payment processor 130, payment processor 130 can retrieve and hold the payment (block 850). In this manner, system 120 can enforce a hold (block 860) on the payment from payment processor 130 to seller 712, such as for a period of time (e.g., 24 hours) to ensure that any disputes are resolved prior to release of the funds to seller 712. If system 120 determines that payment can be released, system 120 can provide an instruction directing payment processor 130 to release the payment to seller 712 (block 870) and can provide a notification to buyer 702 confirming the payment, such as the confirmation illustrated in the example user interface depicted in FIG. 40. Conversely, if system 120 determines that payment is not to be released, system 120 can provide an instruction directing payment processor 130 to refund the payment to buyer 702 (block 880). The payment processing services of payment processor 130 in this embodiment can be provided by a company such as Pound Payments, Inc.

In another embodiment, rather than require buyer 702 to provide a method of payment during each transaction, payment processor 130 can instead bill buyer 702 through an account associated with buyer 702's computing device, such as buyer 702's mobile phone bill. In this manner, system 120 can facilitate a convenient transaction process in which buyer 702 can charge payment on a listing directly to buyer 702's computing device. In this embodiment, in response to receiving the request to pay from client 700 in block 800, system 120 can simply direct client 700 to payment processor 130 rather than implement blocks 810-830. The payment processing services of payment processor 130 in this embodiment can be provided by a company such as Payfone, Inc.

System 120 can also allow buyer 702 to pre-pay for the listing during the listing creation process. In this embodiment, system 120 can indicate that a listing has been prepaid when the listing is displayed to seller 712, such as with a visual cue such as an image or textual note (e.g., “Zaarly verified payment”). The prepayment can be held by payment processor 130 and released by system 120 in the same manner as indicated above.

By implementing the payment process in the manner of these embodiments, system 120 can also facilitate anonymous mobile payments across multiple payment sources/providers and split payments between multiple providers. System 120 can also receive a service fee out of the payment directly from payment processor 130.

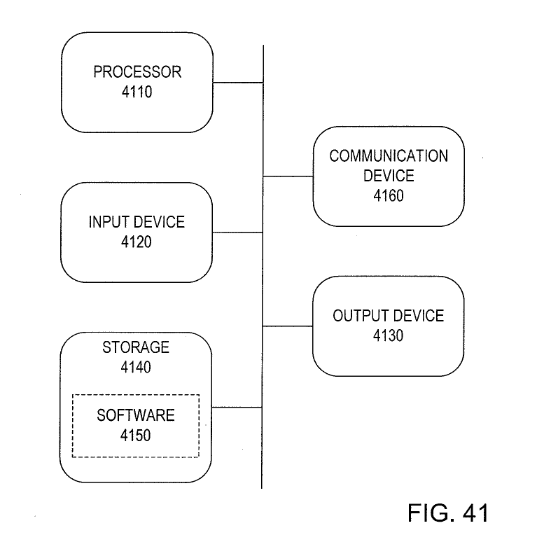

FIG. 41 illustrates an example of a computing device in accordance with one embodiment. In the embodiment illustrated in FIG. 41, the computing device may generally correspond to clients 100, 110, 700 and 710, system 120 and payment processor 130 as described above. The computing device may be any suitable type of microprocessor-based device, such as, for example, a handheld computing device such as a phone or tablet, a personal computer, workstation, or server. The computing device may include, for example, one or more of processor 4110, input device 4120, output device 4130, storage 4140, and communication device 4160.

Input device 4120 may be any suitable device that provides input, such as, for example, a touch screen or monitor, keyboard, mouse, or voice-recognition device. Output device 4130 may be any suitable device that provides output, such as, for example, a touch screen, monitor, printer, disk drive, or speaker.

Storage 4140 may be any suitable device the provides storage, such as, for example, an electrical, magnetic or optical memory including a RAM, cache, hard drive, CD-ROM drive, tape drive or removable storage disk. Communication device 4160 may include any suitable device capable of transmitting and receiving signals over a network, such as, for example, a network interface chip or card. The components of the computing device may be connected in any suitable manner, such as, for example, via a physical bus or wirelessly.

Software 4150, which may be stored in storage 4140 and executed by processor 4110, may include, for example, the application programming that embodies the functionality of the present disclosure (e.g., as embodied in clients 100, 110, 700 and 710, system 120 and payment processor 130 as described above). In some embodiments, software 4150 may include a combination of servers such as application servers and database servers.

Software 4150 can also be stored and/or transported within any computer-readable storage medium for use by or in connection with an instruction execution system, apparatus, or device, such as clients 100, 110, 700 and 710, system 120 and payment processor 130, that can fetch instructions associated with the software from the instruction execution system, apparatus, or device and execute the instructions. In the context of this document, a computer-readable storage medium can be any medium, such as storage 4140, that can contain or store programming for use by or in connection with an instruction execution system, apparatus, or device.

Software 4150 can also be propagated within any transport medium for use by or in connection with an instruction execution system, apparatus, or device, such as clients 100, 110, 700 and 710, system 120 and payment processor 130, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

Network 115 may include any suitable type of interconnected communication system. Network 115 may implement any suitable communications protocol and may be secured by any suitable security protocol. Network 115 can include network links of any suitable arrangement that implements the transmission and reception of network signals, such as, for example, wireless network connections, T1 or T3 lines, cable networks, DSL, or telephone lines.

The computing device may implement any suitable operating system, such as, for example, iOS® provided by Apple Inc. in connection with clients 100, 110, 700 and 710 described above and UNIX in connection with system 120 and payment processor 130 as described above. Software 4150 may be written in any suitable programming language, such as, for example, C, C++ or Java. In various embodiments, application software embodying the functionality of the present disclosure may be deployed in different configurations, such as, for example, in a client/server arrangement or through a Web browser as a Web-based application or Web service, for example.

It will be appreciated that the above description for clarity has described embodiments of the disclosure with reference to different functional units and processors. However, it will be apparent that any suitable distribution of functionality between different functional units or processors may be used without detracting from the disclosure. For example, functionality illustrated to be performed by separate processors or controllers may be performed by the same processors or controllers. Hence, references to specific functional units may be seen as references to suitable means for providing the described functionality rather than indicative of a strict logical or physical structure or organization.

The disclosure may be implemented in any suitable form, including hardware, software, firmware, or any combination of these. The disclosure may optionally be implemented partly as computer software running on one or more data processors and/or digital signal processors. The elements and components of an embodiment of the disclosure may be physically, functionally, and logically implemented in any suitable way. Indeed, the functionality may be implemented in a single unit, in a plurality of units, or as part of other functional units. As such, the disclosure may be implemented in a single unit or may be physically and functionally distributed between different units and processors.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A system comprising:
a client device, and
an online system,
wherein the client device is configured to
receive a request to post a listing,
detect a current location of the client device, and
submit to the online system the request to post the listing and the detected location, and
wherein the online system is configured to
receive from the client device the request to post the listing and the detected location, and
provide the client device with an indication of one or more groups associated with a location that falls within a proximity of the detected location.

2. The system of claim 1, wherein the listing comprises a request for an offer, the request for the offer comprising a description and a price.

3. The system of claim 2, wherein the offer comprises an offer to buy, the description comprises an item or service that a person associated with the listing wants to buy, and the price comprises an amount the person is willing to pay for the item or service.

4. The system of claim 2, wherein the offer comprises an offer to sell, the description comprises an item or service that a person associated with the listing wants to sell, and the price comprises an amount for which the person is willing to sell the item or service.

5. The system of claim 2, wherein the request for the offer comprises multiple quantities of an item or service associated with the listing.

6. The system of claim 5, wherein the client device is configured to accept multiple offers on the listing.

7. The system of claim 5, wherein the online system is configured to accept multiple offers on the listing in accordance with an auction format.

8. The system of claim 1, wherein the detected location comprises latitude and longitude coordinates.

9. The system of claim 1, wherein the online system is configured to post the listing.

10. The system of claim 1, wherein the online system is configured to push the listing to members of one or more groups associated with a location that falls within a proximity of the detected location.

11. A system comprising:
a client device, and
an online system,
wherein the client device is configured to
receive a request to browse offers on a listing posted on the online system,
detect a current location of the client device, and
submit to the online system the request to browse offers and the detected location, and
wherein the online system is configured to
provide to the client device offers on the listing sorted by location nearest the detected location.

12. The system of claim 11, wherein the offers provided to the client device are displayed in a list.

13. The system of claim 11, wherein the offers provided to the client device are displayed in a geospatial manner.

14. The system of claim 13, wherein each of the offers displayed in the map view is identified by a marker indicating a price associated with the respective offer.

15. A method comprising:
providing, by an online system to a second client device, a listing associated with a first client device, the listing comprising a first price associated with an item or service,
receiving, by the online system, an offer from the second client device on the listing, the offer comprising a second price associated with the item or service,
determining, by the system, whether the second price degrades the listing,
rejecting, by the system, the offer in response to a determination that the second price degrades the listing, and
providing, by the system, the offer to the first client device in response to a determination that the second price does not degrade the listing.

16. The method of claim 15, wherein
the first price comprises an amount a person associated with the listing is willing to pay for an item or service,
the second price is determined to degrade the listing if the second price is lower than the first price, and
the second price is determined not to degrade the listing if the second price is not lower than the first price.

17. The method of claim 15, wherein
the first price comprises an amount for which a person associated with the listing is willing to sell an item or service,
the second price is determined to degrade the listing if the second price is higher than the first price, and
the second price is determined not to degrade the listing if the second price is not higher than the first price.

18. A method comprising:
receiving, by an online system, a request from a first client device to make a payment on a listing,
directing, by the online system, the first client device to a payment processor system, and
enforcing, by the online system, a hold on the payment on the listing after funds for the payment have been transferred to the payment processor system.

19. The method of claim 18, further comprising establishing, by the online system, a transaction session for the payment with a payment processor system, and wherein the directing comprises redirecting, by the online system, the first client device to the transaction session of the payment processor system.

20. The method of claim 18, wherein the enforcing of the hold comprises
waiting a period of time, and
directing the payment processor system to release the funds to complete the payment on the listing in response to a lack of a dispute associated with the payment during the waiting period.

21. The method of claim 18, wherein the enforcing of the hold comprises
waiting a period of time, and
directing the payment processor system to refund the transferred funds to the first client device in response to a dispute associated with the payment during the waiting period.
